(19) United States
(12) Patent Application Publication
(10) Pub. No.: US 2010/0318802 A1
(43) Pub. Date: Dec. 16, 2010

(54) SYSTEMS AND METHODS FOR ESTABLISHING A SECURE COMMUNICATION CHANNEL USING A BROWSER COMPONENT

(76) Inventor: Ajit Balakrishnan, Maharashtra (IN)

Correspondence Address: Ajit Balakrishnan;REDIFF.COM INDIA LIMITED, Mahalaxmi Engineering Estate, L.J. Road #1, Mahim (West), Mumbai, 400016, omitted

(21) Appl. No.: 12/743,859

(22) PCT Filed: Nov. 20, 2008
(86) PCT No.: PCT/IN08/00781

§ 371 Date: Aug. 18, 2010

(30) Foreign Application Priority Data
Nov. 20, 2007 (IN) 2288/MUM/2007

(51) Int. Cl. H04L 9/32; G06F 21/00

(52) U.S. Cl. 713/172; 726/4; 726/3; 726/5

(57) ABSTRACT

A system for providing a secure channel for communication comprises a client comprising a browser, a secure server and a browser component installed on the client that enables a user to establish a connection with the secure server, the browser component configured to generate a first token. The secure server is configured to generate a second token, and wherein the client is provided with access to the secure server upon verification of the first token and the second token.

### BACKGROUND OF THE INVENTION

1. Field of the Invention

This disclosure relates to establishment of secured communication channels over the internet, and more specifically to establishment of secured communication channels between a server and a client.

2. Description of the Related Art

Present day computer systems connect and exchange information extensively through telecommunications networks, such as the Internet, for example. These interactions involve many transactions that may require a user's identity information such as, for example, login information, passwords, social security information or other user credentials, to be disclosed. This user identity information is sometimes under threat due to malicious agents or social attacks such as phishing attacks, in which a “phisher” misguides a user to fake website that looks substantially identical to the a genuine website. Misguiding the user to the fake website may be done through several means, including emails, links on other websites, deceptively similar looking website addresses (or URL's), among various others. Once on the fake website, the user is required to disclose his or her identity information to the phishing website. In this way, the user security information is compromised and this information may then be used by the phisher for purposes malicious to or undesirable for the user.

While phishing is a relatively recent phenomenon, the intensity and the sophistication of phishing attacks have increased significantly in the past few years. Comparatively, the awareness of an average user about such attacks, and the user's ability to safeguard against such attacks remains very minimal. Accordingly, a high risk of unsecured transactions over the internet exists, and such loopholes may be exploited to the detriment of the users of the internet, including organizations and individuals.

While many solutions exist that attempt to “clean up” a user's computer system of any malicious ware, the ability of such agents to protect unsuspecting users against organized identity theft is limited. Other measures employed by various websites, such as digital certificates among others are also limited in their ability to prevent identity theft. An average user may still be a victim to various new and innovative techniques employed by the phishers or malicious agents intending to steal a user's identity, for example.

Therefore, there is a need in the art for enabling a user to access information through secure communication channels.

### SUMMARY

Embodiments of the present invention comprise a system and method for authenticating a communication channel over a communication network. In one embodiment a method for authenticating a communication channel over a communication network is described. The method comprises establishing a connection between a client and a secure server, authenticating the client and the secure server and providing the client access to information on the secure server upon authentication.

In another embodiment, a system for providing a secure channel for communication is provided. The system comprises a client comprising a browser, a secure server and a browser component installed on the client that enables a user to establish a connection with the secure server, the browser component configured to generate a first token. The secure server is configured to generate a second token, and wherein the client is provided with access to the secure server upon verification of the first token and the second token.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of a system in which a trusted two-way authenticated communication channel is established;

FIG. 2 is a flow chart illustrating a manner in which a secure communication channel is established between two computing devices according to one aspect of the present invention; and

FIG. 3 is a diagrammatic view of a web browser that implements a browser component according to one aspect of the invention.

### DETAILED DESCRIPTION

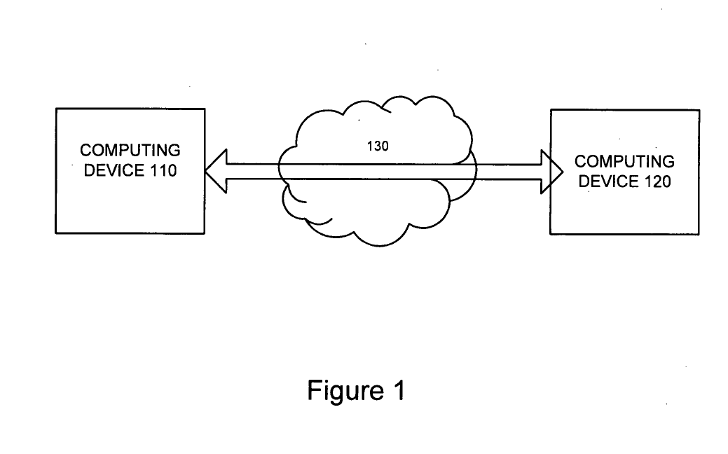

FIG. 1 is a block diagram of a system 100 in which trusted two-way authenticated communication channels may be established and used. The system 100 includes two computing devices 110 and 120, connected over a network 130. Each component is described in further detail below.

The computing device 110 is representative of a class of computing devices which may be any device with a processing unit and memory that may execute instructions. Computing devices may be personal computers, computing tablets, set top boxes, video game systems, personal video recorders, telephones, personal digital assistants (PDAs), portable computers, laptop computers, fax machines, cell phones and special purpose devices. Computing devices have processor and memory. These computing devices may run an operating system, including, for example, variations of the Linux, Unix, MS-DOS, Microsoft Windows, Palm OS, and Apple Mac OS X operating systems. Further, these computing devices may run several applications, such as word processing, games, browsers among others.

Similarly computing device 120 is representative of a class of server computers that comprise confidential information that is intended to be accessible to only authentic users of the server computer. The computing device 120 may include similar, additional or lesser components than the computing device 110, depending upon the functionality of the computing device 120. The computing device 120 is configured to be accessible over a communications network 130, and the computing device 120 may communicate with computing device 110 over network 130.

The network 130 provides a platform for communications between the computing devices 110, 120. The network 130 may be or include local-area networks (LANs), wide-area networks (WANs), metropolitan-area networks (MANs), distributed networks and other similar networks in which computing devices may be linked together. The network 130 may provide lower layer network support for computing devices to interact with one another. The network 130 may be packet-switched and may comprise a common or private bi-directional network, and may be, for example the Internet. The network 130 may be wired or wireless. In addition, the network 130 may be configured based on client-server architecture, a peer-to-peer architecture, or any other distributed computing system architecture. Further, the network 130 may be configured to comprise additional components so as to ensure a scalable solution.

The computing device 110 communicates with computing device 120 over network 130. An authentication technique is applied to both computing devices in order to provide a secure communication channel between the two computing devices. Once the two computing devices are authenticated, a secure communication channel is established between them. The method by which the a secure communication channel is established between the two computing devices is described in further detail below.

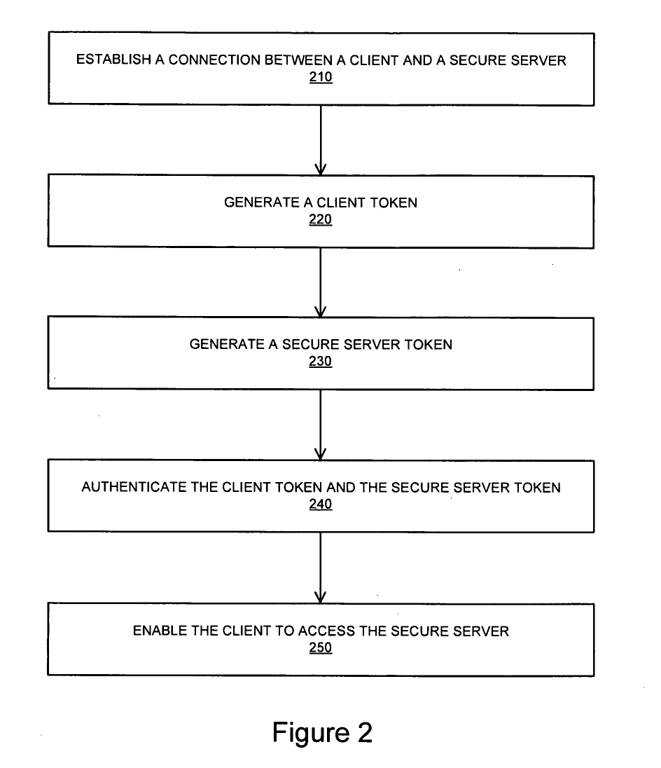

FIG. 2 is a flow chart illustrating a manner in which a secure communication channel is established between two computing devices according to one aspect of the present invention. Each step of the flow chart is described in further detail below.

At step 210, a connection is established between the first and second computing devices. As an example, the first computing device is a client and the second computing device is a secure server. A browser residing in the client is used as an interface to access information stored on the secure server.

At step 220, a first token referred to as a client token is generated by the client. In one embodiment, the client token is generated by a browser component. In a specific embodiment the browser component is a toolbar. The toolbar further includes a search field that enables users to conduct searches on or through the network 130, by entering search queries into the search field.

At step 230, a second token referred to as a secure server token is generated by the secure server. In one embodiment, the client and the secure server tokens comprises an alphanumeric key, a digital certificate, among various other similar uniquely identifying digital data.

At step 240, the client token and the secure server token are authenticated. Specifically, the client token is authenticated by the secure server and the secure server token is authenticated by the client. In a more specific embodiment, the client token and the secure server token are authenticated in parallel.

In an alternate embodiment, one or both of the client token and the secure server token are verified by a secure gateway coupled to one or both of the client and the secure server. The secure gateway is configured to process at least one of the client token and the secure server token. The secure gateway may be resident on the secure server, or any other singular or shared computer resource accessible through the communications network 130.

At step 250, the client is provided with access to the secure server once the authentication at step 240 is performed. More specifically, upon authentication, the client is able to access information stored in a secure zone on the secure server. In one embodiment, the client is allowed to access a ‘login’ page of an internet banking site. Other examples of such information include a ‘block card’ page, ‘order replacement card’ page and the like. Yet other embodiments include access pages for a user's identity information such as

Social Security number, Income Tax records, Health records, Insurance records, and the like on a pertinent server.

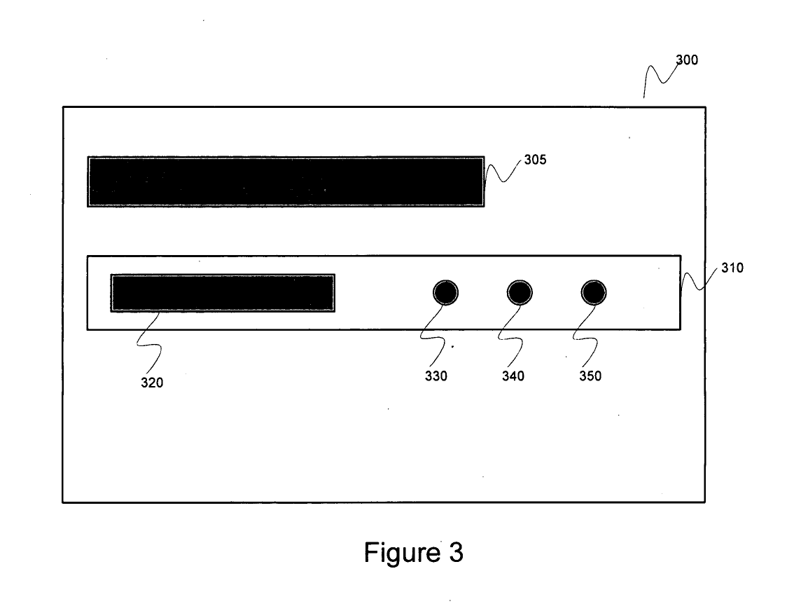

As discussed above, the client token is generated by a browser component that resides on the browser of the client. FIG. 3 is a diagrammatic view of a web browser that implements a browser component according to one aspect of the invention. The web browser is described in further detail below.

Web browser 300 resides on the first computing device or the client and is used to browse through different sections available over the network. The web browser includes a web ID field 305 wherein a web address of a desired remote server on the network may be entered by a user. The browser will then communicate with the remote server to provide the requested information on the remote server to the user.

The web browser 300 further comprises browser component 310. In one embodiment, the browser component is a toolbar, as also illustrated by FIG. 3. The browser component 310 includes a search field 320 that is coupled to a search engine (not shown) on the communications network. The search engine enables a user to locate specific information on or through the communications network 130 by entering a set of words in the search field 320.

The browser further includes one or more functional features such as buttons 330, 340 and 350. These buttons represent links to secure zones within the secure servers, and are initially inactive and are not accessible to the user. When the user requests information and/or services from a secure zone on the secure server, the browser component generates a first token (or client token) and the secure server generates a second token (or secure server token) as is described in the flow chart of FIG. 2. Upon verification of the first and second tokens, the client is authenticated to access information and/or services from the secure zone. Only after the authentication of the client is established, buttons 330, 340 and 350 on the browser component 310 are activated, and thereby made accessible to the user. Such activation of buttons after the establishment of a secure communication channel allows for a secure transaction by the user of the toolbar with the secure server.

According to a specific embodiment, the manner in which the authorization is performed is described in further detail below. As described with reference to FIG. 2, the client and the secure server generate a first token and a second token respectively. Specifically, the client (or the browser component) generates or defines a unique relative identity key Uₐ and a partial shared key Sₐ. Similarly, the secure server generates or defines a unique relative identity key U_{b} and a partial shared key S_{b}. It is noted that each of the partial shared keys is at least partially derived from the respective unique identity unique relative identity key. Further, an encryption key is defined or generated for communication between the client and secure server, and the encryption key is based on the unique relative identity key Uₐ and unique relative identity key U_{b}. The encryption key is known to both the client (browser component) and the secure server.

In one embodiment, the secure gateway (acting as a third party) may also generate one or more of the unique relative identity key and the partial shared key for the client and/or the secure server, and is accordingly aware of the encryption key.

The partial shared key Sₐ is transmitted to the secure server. Similarly, the partial shared key S_{b} is transmitted to the client. The client generates a first intermediate key Iₐ using the shared key S_{b} and the client unique relative identity key Uₐ. The first intermediate key Iₐ is transmitted to the secure server.

Similarly, the secure server generates a second intermediate key I_{b} using the shared key Sₐ and the secure server unique relative identity key U_{b}. The second intermediate key I_{b} is transmitted to the client. The intermediate keys Iₐ and I_{b} may be referred to as the first and the second tokens respectively.

Thus the client and the secure server have both intermediate keys. Using the unique relative identity key Uₐ and the intermediate key I_{b}, the client generates a client encryption key. Using the unique relative identity key U_{b} and the intermediate key Iₐ, the secure server generates a secure server encryption key. The various functions used to form the intermediate keys and the encryption keys are configured to be associative functions, and therefore, the encryption keys generated by the client (browser component) and the secure server are expected to match. Accordingly, the encryption keys generated by the client and the secure server are compared. If a match exists, the communication channel established is said to be authenticated. Thereafter, the client is authenticated to access a secure zone on the secure server.

The encryption key generated at the client may be compared with the known value for the encryption key at the client location itself. Similarly, the encryption key generated at the secure server may be compared with the known value for the encryption key at the secure server location.

Further, the encryption key may further be used to encrypt/decrypt the authentication communications between the client and the server. It is noted that at the encryption key or the unique relative identity keys of the client or the secure server are never disclosed outside the browser component or the secure server, and are neither transmitted over the network, except for those embodiments in which a secure gateway may possess information on the unique relative identity key for the client and the secure server and the encryption key.

Such a mutual authentication between the browser component and the secure zone within a secure server allows for a highly enhanced level of security, and protection against identity theft.

Various embodiments of the present invention have been provided. According to one inventive aspect, the toolbar advantageously provides an enhanced security for internet transactions using a simple and familiar interface, viz. the toolbar. The inventive apparatus advantageously provides a secure communication for any user to transact over the internet without the need for complicated maneuvers or equipments (such as a dongle based token). According to various embodiments of the present invention, the inventive aspects provide a simple, easily accessibly and a familiar tool usable for establishing securing communication channels for internet resources having sensitive information.

While the foregoing is directed to embodiments of the present invention, other and further embodiments of the invention may be devised without departing from the basic scope thereof, and the scope thereof is determined by the claims that follow.

1. A method for authenticating a communication channel over a communication network, the method comprising:
establishing a connection between a client and a secure server;
authenticating both the secure server and the client; and
providing the client access to information and/or services on the secure server upon authentication.

2. The method of claim 1 further comprising generating a client token and a secure server token, wherein authenticating comprises verifying the client token and the secure server token.

3. The method of claim 2, wherein authenticating comprises verifying the client token by the secure server, and verifying the secure server token by the client

4. The method of claim 3, wherein the establishing connection comprises using a browser component.

5. The method of claim 3, wherein the browser component comprises a field for providing network based search.

6. The method of claim 3, wherein the client token is generated by the browser component.

7. The method of claim 2, wherein generating the client token involves processing a shared key of the secure server and a unique relative identity key of the client.

8. The method of claim 7, wherein the shared key is derived at least in part the from a unique relative identity key of the secure server.

9. The method of claim 8, wherein verifying the secure server token by the client comprises generating an encryption key from the secure server token and the unique relative identity key of the client, and comparing the generated encryption key with a known value of the encryption key.

10. The method of claim 2, wherein the secure server token is generated by the secure server.

11. The method of claim 2, wherein generating the secure server token involves processing a shared key of the client and a unique relative identity key of the secure server.

12. The method of claim 11, wherein the shared key of the client is derived at least in part the from a unique relative identity key of the client.

13. The method of claim 12, wherein verifying the client token by the secure server comprises generating an encryption key from the client token and the unique relative identity key of the secure server, and comparing the generated encryption key with a known value of the encryption key.

14. The method of claim 2, wherein the information and/or services on the secure server comprises an information stored on a secure zone on the secure server and/or services provided by the secure zone on the server.

15. The method of claim 14, wherein the secure server is a bank server, and the secure zone comprises a page providing login access to user's account.

16. The method of claim 14, wherein the secure server is a bank server, and the secure zone comprises a page providing funds transfer by the user.

17. The method of claim 14, wherein the secure server is an identity record server, and the secure zone comprises a page providing a login access to a user's identity record.

18. The method of claim 2, wherein the verifying occurs in parallel.

19. The method of claim 5, further comprising activating functional features on the browser component upon authentication.

20. The method of claim 19, wherein the functional features include information and/or services allowed by the secure server conditional upon authentication of the client.

21. The method of claim 2, wherein a secure gateway is associated with at least one of the secure server or the client, and wherein the secure gateway generates at least one of the token for the secure server, and the token for the client.

22. The method of claim 2, wherein a secure gateway is associated with at least one of the secure server and the client, and wherein the secure gateway verifies at least one of the client token, and the secure server token.

23. A system for providing a secure channel for communication comprising:
a client comprising a browser;
a secure server; and
a browser component installed on the client that enables a user to establish a connection with the secure server, wherein the client is provided with access to the secure server upon authentication of the secure server and the client.

24. The system of claim 23, wherein the browser component authenticates the secure server and the secure server authenticates the client based on the browser component.

25. The system of claim 24, wherein the browser component generates a client token and the secure server generates a secure server token.

26. The system of claim 23, wherein the client communicates with the secure server via a communication channel.

27. The system of claim 25, wherein the browser component further comprises a plurality of functional features that are activated upon verification of the client token and the secure server tokens.

28. The system of claim 25, wherein the browser component comprises a search field.

29. A system for providing secure communication over a communication channel, the system comprising:
a web browser;
a browser component configured to provide a secure communication channel over a network.

30. The system of claim 29, wherein the browser component is a toolbar.

31. The system of claim 30, wherein the tool bar comprises a search field.

32. The system of claim 31, wherein the toolbar provides the secure communication channel based upon an authentication of the toolbar and a remote secure server.

33. The system of claim 32, wherein the authentication comprises a mutual authentication of the toolbar and the secure server.

34. A computer readable storage medium having processor executable instructions that when executed, cause a computing device to perform a method, the method comprising:
activating a toolbar on the computing device;
establishing a connection between the computing device and an external entity;
generating a client token from the toolbar and receiving a secure server token from the external entity at the toolbar;
verifying the secure server token; and
providing the toolbar access to the external entity in response to the client token being verified by the external entity.

35. A computer readable storage medium having processor executable instructions that when executed, cause a computing device to perform a method, the method comprising:
establishing a connection between the computing device and an external entity comprising a toolbar;
receiving a client token from the toolbar and generating a secure server token by the computing device;
verifying the client token; and
providing the toolbar access to the computing device in response to the secure server token being verified by the toolbar.
